(19) United States
(12) Patent Application Publication
(10) Pub. No.: US 2024/0348021 A1
(43) Pub. Date: Oct. 17, 2024

(54) SUBSEA CABLE BUNDLE INSTALLATION

(71) Applicant: Equinor Energy AS, Stavanger (NO)

(72) Inventors: Odd KVELLO, Oslo (NO); Karl Atle STENEVIK, Sandsli (NO)

(73) Assignee: Equinor Energy AS, Stavanger (NO)

(21) Appl. No.: 18/292,592

(22) PCT Filed: Jul. 8, 2022
(86) PCT No.: PCT/NO2022/050171

§ 371 Date: Jan. 26, 2024

(30) Foreign Application Priority Data
Jul. 28, 2021 (GB) 2110844.4

(51) Int. Cl. H02G 1/10; E21B 17/01; H01B 9/00

(52) U.S. Cl. CPC H02G 1/10; E21B 17/015; H01B 9/005

(57) ABSTRACT

A method of installing a subsea cable bundle including an umbilical and at least one direct current and fibre optic (DCFO) cable attached to an outside of the umbilical includes connecting a first end of the cable bundle to a pulling head, lowering the first end of the cable bundle into the se, connecting the pulling head to a winch cable of a winch (the winch may be connected before or after lowering the first end), the winch being located on a platform and the winch cable extending from the platform into the sea through a J-tube, and using the winch to pull the first end of the cable bundle up to the platform through the J-tube. The method further includes laying the cable bundle on the seafloor, and at a target location, at or close to a subsea structure, detaching the DFCO cable from the umbilical and connecting the DCFO cable and the umbilical at their second ends to the subsea structure.

### TECHNICAL FIELD

The present invention concerns a subsea cable bundle installation procedure, and in particular a procedure for installation of a cable bundle comprising a direct current and fibre optic cable.

### BACKGROUND

For subsea hydrocarbon production, hydraulic and/or electric power and control signals have to be transmitted to the subsea structures. For example, an umbilical comprising a bundle of tubes and cables can be connected from a platform at the surface to a well template on the seafloor.

Recently, a new technology using direct current and fibre optic (DCFO or DC/FO) cables to provide increased power and signals over longer subsea distances has been suggested. FIG. 1 shows a schematic diagram of the setup. A short (<1 km) riser umbilical 1 containing the DCFO cable 2 and fluid lines runs from a platform 3 on the surface 4 to the seafloor 5. On the seafloor 5, the umbilical is connected to a riser umbilical end termination 6, which splits out the DCFO cable 2. A second, longer umbilical 7 (without the DCFO cable 2 but containing the fluid lines) is connected between the riser umbilical end termination 6 and a subsea structure 8. The DCFO cable 2 needs to be split out because manufacturing constraints do not allow for a sufficiently long DCFO cable to be integrated inside the umbilical 7 all the way to the subsea structure 8. The DCFO cable 2 is separately connected to the subsea structure 8 to provide power and control signals to the subsea structure 8.

### SUMMARY

A potential downside with the use of DCFO cables is the increased costs and installation times associated with separate laying and trenching the DCFO cable to the subsea structure.

According to a first aspect of the present disclosure there is provided a method of installing a subsea cable bundle comprising an umbilical and at least one direct current and fibre optic (DCFO) cable attached to an outside of the umbilical. The method comprises connecting a first end of the cable bundle to a pulling head, lowering the first end of the cable bundle into the sea, connecting the pulling head to a winch cable of a winch (the winch may be connected before or after lowering the first end), the winch being located on a platform and the winch cable extending from the platform into the sea through a J-tube, and using the winch to pull the first end of the cable bundle up to the platform through the J-tube. The method further comprises laying the cable bundle on the seafloor, and at a target location, at or close to a subsea structure, detaching the DFCO cable from the umbilical and connecting the DCFO cable and the umbilical at their second ends to the subsea structure.

The target location may be up to 3 km from the subsea structure, for example 0.5 km from the subsea structure.

Typically the cable bundle contains two of said DCFO cables. Two DCFO cables can provide increased data rates or redundancy in the system.

The umbilical is typically a static umbilical, which can be less complex than a dynamic umbilical.

The subsea structure may be a well template. The umbilical may provide fluid lines to the well template and the DCFO cable may provide power and control signals template.

The step of connecting the first end of the cable bundle to the pulling head may comprise hang-off of at least the umbilical within the pulling head. For example, the step of connecting may comprise using friction clamps.

The step of pulling may comprise pulling the cable bundle through a seal at a lower end of the J-Tube. After pulling the first end of the cable bundle, the seal can be activated to seal a lower end of the J-tube against the umbilical and against the DCFO cable(s).

The step of laying typically comprises laying the cable bundle from a laying vessel. The bundle may be unreeled on the vessel as the vessel travels towards the subsea structure. The step of laying may comprise laying at least 2 km of the cable bundle on the seafloor. The bundle may be long, for example, 30 to 50 km.

According to a second aspect of the present disclosure there is provided a cable bundle. The cable bundle comprises an umbilical comprising a plurality of tubulars for providing fluid lines to a subsea structure, and at least one direct current and fibre optic (DCFO) cable attached to an outside of the umbilical. The cable bundle may be installed according to the method of the first aspect.

The cable bundle may comprise two of said DCFO cables. The umbilical is typically a static umbilical. The cable bundle have a length greater than 2 km, e.g. in the range of 30 km to 50 km.

### BRIEF DESCRIPTION OF DRAWINGS

FIG. 1 is a schematic diagram of an umbilical connected to a subsea structure;

FIG. 2 is a schematic diagram of a subsea installation comprising a cable bundle from a platform to a subsea structure according to an embodiment;

FIG. 3A to 3F show steps of a method of installing a subsea cable bundle according to an embodiment; and

FIG. 4 is a schematic diagram of a cross section of a cable bundle according to an embodiment.

### DETAILED DESCRIPTION

FIG. 2 is a schematic diagram of a completed subsea umbilical installation according to an embodiment. Instead of having a riser umbilical with a DCFO cable inside the umbilical that then has to be split out, the DCFO cable 2 is attached to the outside of the umbilical 7 to form a cable bundle 9, which runs all the way from the platform 3 at the surface 4, via a J-Tube 10, to a subsea structure 8 on the seafloor 5. The DCFO cable 2 is disconnected/split from the umbilical 7 close to the subsea structure 8, so that the umbilical 7 and the DCFO cable 2 can be connected to different parts of the subsea structure 8. For example, the subsea structure 8 may be located >30 km from the platform 3 and the DCFO cable 2 can be split from the umbilical at a location around 1 km from the subsea structure 8. Hence, the DCFO cable 2 can supply electrical power and control signals from the platform 3 to the subsea structure 8 while the umbilical 7 can provide hydraulic power for controlling valves of the subsea structure 8. The umbilical 7 is a static umbilical, which is not designed for significantly fluctuating loads, but which may be less complex than a similar dynamic umbilical.

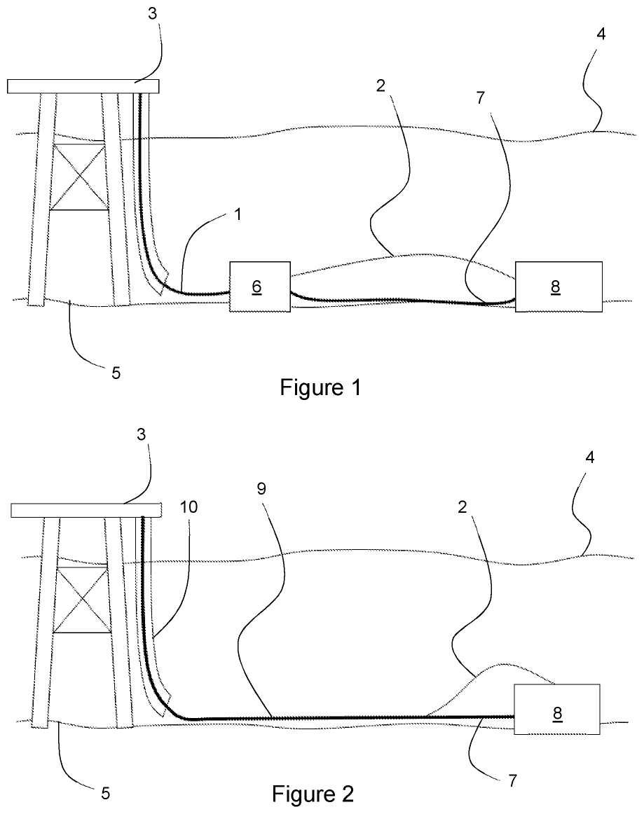

The proposed installation removes the need for a separate subsea node for splitting out the DCFO cable (such as the breakout box 6 in FIG. 1). Furthermore, no separate trenching or laying operation is required for the DCFO cable 2, which instead can be laid together with the umbilical 7 substantially all the way from the platform to the subsea structure 8.

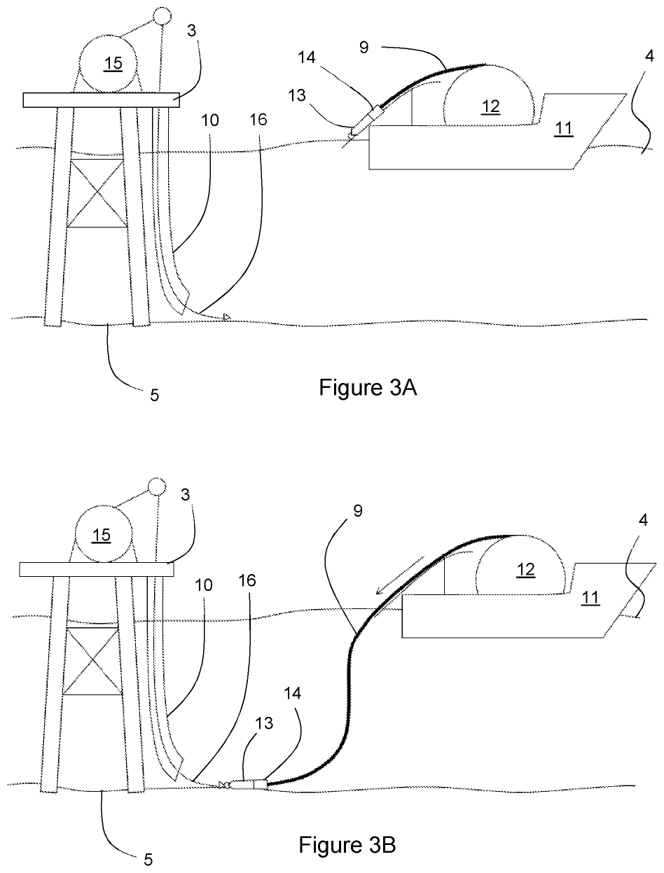

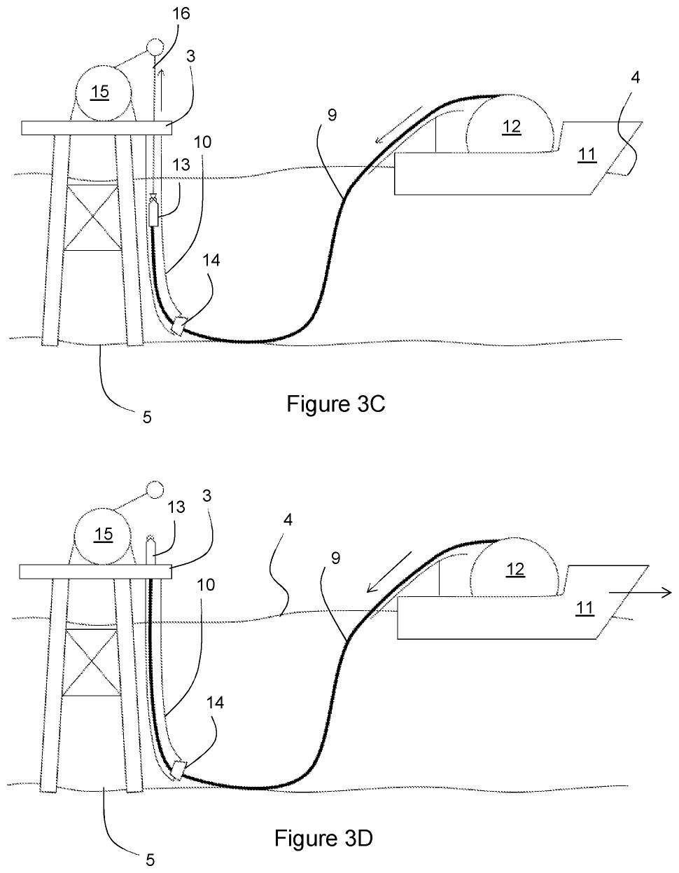

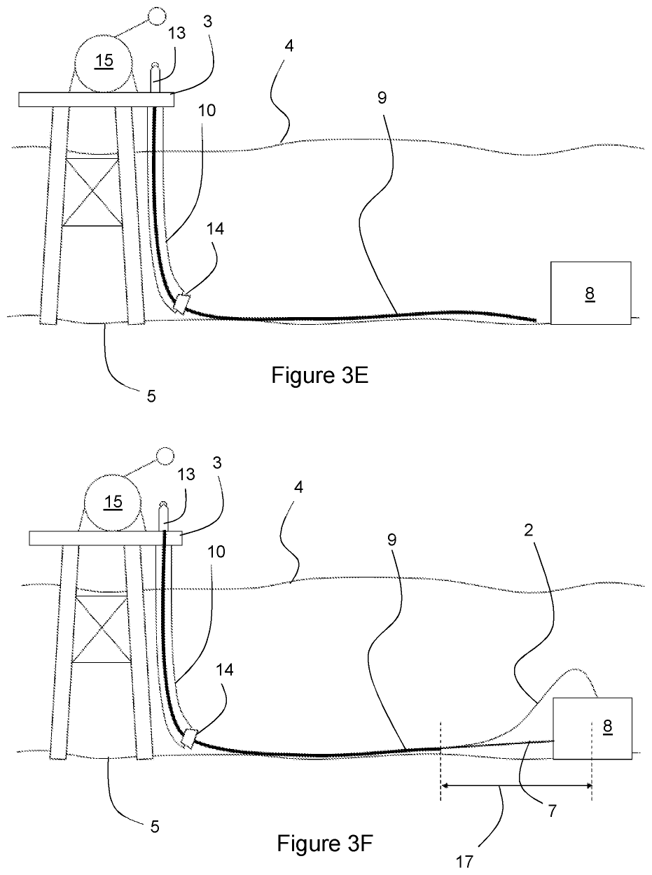

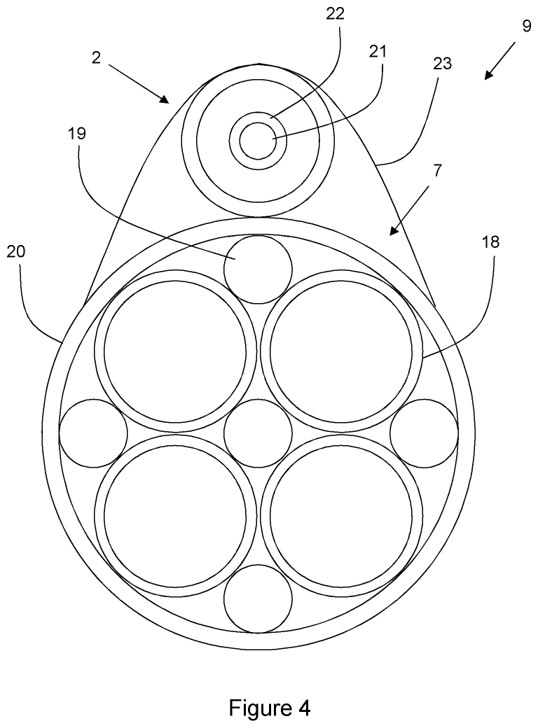

FIGS. 3A to 3E illustrate a sequence of steps in the installation of a cable bundle 9 with an umbilical 7 and DCFO cable 2 according to an embodiment.

FIG. 3A shows a laying vessel 11 with a reel 12 holding the cable bundle 9 with the umbilical 7 and attached DCFO cables 2. The cable bundle 9 is connected to a pull in head 13 and J-Tube seal 14 on the laying vessel 11. The pull in head is configured to hold the umbilical 7 and the DCFO cables 2 of the cable bundle. For example, the pull in head 13 may comprise friction clamps to clamp and hang-off at least the umbilical 7 of the cable bundle 9. A winch 15 is located on a platform 3 with a winch cable 16 lowered down through the J-Tube 10.

FIG. 3B shows the end of the cable bundle 9 with the pull in head 13 lowered to the seafloor 5. The pull in head 13 is connected to the winch cable 16. In other embodiments, the winch cable 16 may be connected to the pull in head 13 at the surface before lowering the end of the cable arrangement 9

FIG. 3C shows the end of the cable bundle 9 being pulled by the winch 15 and the pull in head 13 up the J-Tube 10 to the platform 3. The J-Tube seal 14 is connected to the opening of the J-Tube 10 as the pull in head 13 passes through the opening.

FIG. 3D shows the hang off of the cable bundle 9 on the platform 3. The J-Tube seal 14 can be activated to seal the J-Tube 10 against the cable bundle 9. The laying vessel 11 moves away from the platform 3 while feeding out the cable bundle 9 from the reel 12 to lay the cable bundle on the seafloor 5.

FIG. 3E shows the cable bundle 9 laid on the seafloor 5 to a target location by the subsea structure 8 (e.g. a well template).

FIG. 3F shows the final step of disconnecting the DCFO cables 2 from the umbilical 7 at a distance 17 from the subsea structure 8, and connecting the DCFO cables 2 and the umbilical 7 to respective parts of the subsea structure 8. For example, the DCFO cables 2 may be connected to a step down box of the subsea structure 8, and the umbilical may be connected to a hydraulic control module of the subsea structure 8.

FIG. 4 shows a schematic cross section of a cable bundle 9 according to an embodiment. The cable bundle 9 comprises an umbilical 7 comprising tubulars 18 for fluid and steel rods 19 for stability, all encased by an outer layer 20. The tubulars 18 may be metal tubes, thermoplastic hoses or composite tubes for example. The cable bundle further comprises a DCFO cable 2 comprising an inner fibre optic cable 21 and a conductor 22 for transmitting electric power. The DCFO cable 2 is attached to the umbilical by attachment means 23, such as straps fitted around the umbilical 7 and DCFO cable 2 at intervals along the length of the cable bundle 9.

While specific embodiments are described above, the skilled person would be able to make further embodiments that fall within the scope of the claims.

1. A method of installing a subsea cable bundle comprising an umbilical and at least one direct current and fibre optic, DCFO, cable attached to an outside of the umbilical, the method comprising:
connecting a first end of the cable bundle to a pulling head;
lowering the first end of the cable bundle into the sea;
connecting the pulling head to a winch cable of a winch, the winch being located on a platform and the winch cable extending from the platform into the sea through a J-tube;
using the winch to pull the first end of the cable bundle up to the platform through the J-tube;
laying the cable bundle on the seafloor; and
at a target location, at or close to a subsea structure, detaching the DFCO cable from the umbilical and connecting the DCFO cable and the umbilical at their second ends to the subsea structure.

2. The method according to claim 1, wherein the target location is up to 3 km from the subsea structure.

3. Tie method according to claim 1, wherein the cable bundle contains two of said DCFO cables.

4. The method according to claim 1, wherein the umbilical is a static umbilical.

5. The method according to claim 1, wherein the subsea structure is a well template.

6. The method according to claim 1, wherein said step of connecting the first end of the cable bundle to the pulling head comprises hang-off of at least the umbilical within the pulling head.

7. The method according to claim 1, wherein said step of connecting comprises using friction clamps.

8. The method according to claim 1, wherein said step of pulling comprises pulling the cable bundle through a seal at a lower end of the J-Tube.

9. Tie method according to claim 8 and further comprising, after pulling the first end of the cable bundle, activating the seal to seal a lower end of the J-tube against the umbilical and against the DCFO cable(s).

10. The method according to claim 1, wherein said step of laying comprises laying the cable bundle from a laying vessel.

11. The method according to claim 1, wherein said step of laying comprises laying at least 2 km of the cable bundle on the seafloor.

12. A cable bundle comprising:
an umbilical comprising a plurality of tubulars for providing fluid lines to a subsea structure; and
at least one direct current and fibre optic, DCFO, cable attached to an outside of the umbilical.

13. The cable bundle according to claim 12, comprising two of said DCFO cables.

14. The cable bundle according to claim 12, wherein the umbilical is a static umbilical.

15. The cable bundle according to claim 12, wherein the cable bundle has a length greater than 2 km.
